(19) United States
(12) Patent Application Publication
(10) Pub. No.: US 2019/0283760 A1
(43) Pub. Date: Sep. 19, 2019

(54) DETERMINING VEHICLE SLOPE AND USES THEREOF

(71) Applicant: Uber Technologies, Inc., San Francisco, CA (US)

(72) Inventors: Kenneth James Jensen, Alameda, CA (US); Edward Henry Lim, Pacifica, CA (US)

(21) Appl. No.: 16/153,312

(22) Filed: Oct. 5, 2018

Related U.S. Application Data
(60) Provisional application No. 62/644,956, filed on Mar. 19, 2018.

(51) Int. Cl. B60W 40/076; G01C 9/02; G05D 1/02; B60W 50/00

(52) U.S. Cl. CPC B60W 40/076; G01C 9/02; G05D 1/0223; B60W 50/00; B60W 2050/0083; B60W 2050/0052; B60W 2550/142; B60W 2710/0605; B60W 2520/06; G05D 1/0276

(57) ABSTRACT

Various examples are directed to systems and methods of monitoring a vehicle. At least one processor unit may access first slope data indicative of a first slope referenced to a cab of the vehicle and access second slope data indicative of a second slope independent of the cab of the vehicle. The at least one processor unit may generate cab tilt data indicative of a cab tilt of the cab using the first slope data and the second slope data.

### CLAIM FOR PRIORITY

This application claims the benefit of priority of U.S. Provisional Application No. 62/644,956, filed Mar. 19, 2018, which is hereby incorporated by reference in its entirety.

### FIELD

The document pertains generally, but not by way of limitation, to devices, systems, and methods for operating an autonomous vehicle.

### BACKGROUND

An autonomous vehicle is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for determining and using vehicle slope.

FIG. 2 depicts a block diagram of an example vehicle according to example aspects of the present disclosure.

FIG. 3 is a flowchart showing one example of a process flow that may be executed by a slope system to determine cab tilt.

FIG. 4 is a flowchart showing one example of a process flow that may be executed by a slope system to determine an example cab-independent slope for a vehicle.

FIG. 5 is a flowchart showing one example of a process flow that may be executed by a slope system to determine a cab-independent slope for a vehicle.

FIG. 6 is a flowchart showing one example of a process flow that may be executed by a slope system to determine an example cab-independent slope for a vehicle from a vehicle pose.

FIG. 7 is a diagram showing an example slope and adjusted slope for a vehicle.

FIG. 8 is a flowchart showing one example of a process flow that may be executed by a vehicle autonomy system to generate a vehicle slope based on a pose estimate and on slope sensor data.

FIG. 9 is flowchart showing one example of a process flow that may be executed by a vehicle autonomy system to adjust sensor data in view of detected cab tilt.

FIG. 10 is a diagram showing an example workflow that may be executed, for example, by a throttle command system and/or motion planner to modify a throttle command in view of a slope measurement, for example, made by a slope system as described herein.

FIG. 11 is a block diagram showing one example of a software architecture for a computing device.

FIG. 12 is a block diagram illustrating a computing device hardware architecture, within which a set or sequence of instructions can be executed to cause a machine to perform examples of any one of the methodologies discussed herein.

### DESCRIPTION

Examples described herein are directed to systems and methods for determining and/or using vehicle slope, for example, in an autonomous vehicle.

In an autonomous or semi-autonomous vehicle (collectively referred to as an autonomous vehicle (AV)), a vehicle autonomy system, sometimes referred to as an AV stack, controls one or more of braking, steering, or throttle of the vehicle. In a fully-autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input.

It is sometimes desirable to accurately determine the slope of the roadway where an autonomous vehicle is present. For example, some vehicles experience cab tilt when under acceleration or deceleration. Cab tilt occurs when the slope of the cab deviates from the slope of the chassis and/or wheels. Cab tilt can affect the operation of the vehicle autonomy system and/or various sensors that provide signals to the vehicle autonomy system. For example, cab tilt can change the field of view of remote-detection sensors mounted on or in the cab, thus changing the data provided to the vehicle autonomy system. Consider an example vehicle with a light detection and ranging (LIDAR) sensor mounted on the cab. If the cab tilts forward, the road surface ahead may enter or become more prominent in the field of view of the LIDAR. Without appropriate compensation, this can cause the vehicle autonomy system to mistake the road for an object in the vehicle's path. Similar considerations apply with respect to other remote-detection sensors mounted on the cab, such as radio detection and ranging (RADAR) sensors, sound navigation and ranging (SONAR) sensors, cameras, etc.

A slope system described herein is configured to use slope measurements to detect cab tilt. The slope system is configured generate a cab-referenced slope and a cab-independent slope. The cab-referenced slope is a slope of the vehicle that includes a slope of the cab. The cab-referenced slope, for example, may be determined from a slope sensor such as an inclinometer, gyroscopic sensor, accelerometer, etc. The cab-independent slope may be determined, for example, by comparing the position and velocity of the vehicle to a known grade of the position, as indicated by map data. The slope system determines the cab tilt by finding a difference between the cab-referenced slope and the cab-independent slope. The cab tilt determined by the slope system is used by the vehicle autonomy system, for example a pose system thereof, to correct sensor signals to account for field-of-view changes due to cab tilt. Some or all of the slopes determined by the slope system may be used by the vehicle autonomy system, for example, to accurately implement a motion plan, as described herein.

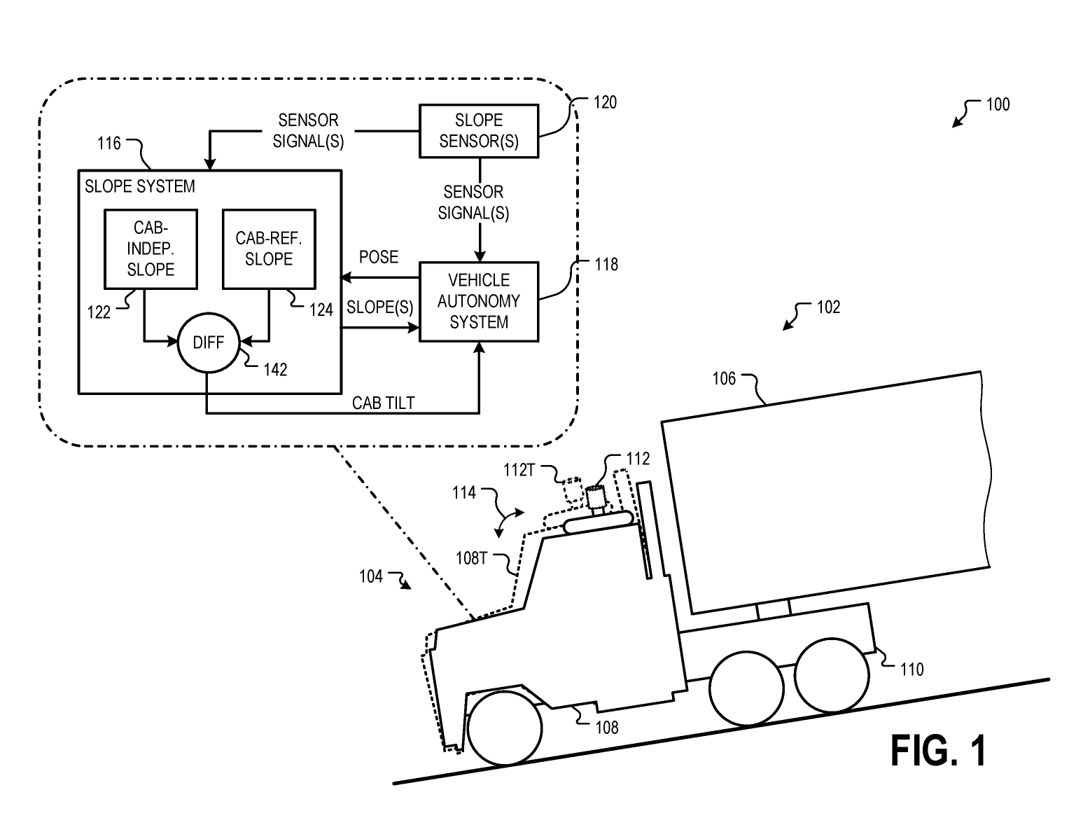

FIG. 1 is a diagram showing one example of an environment 100 for determining and using vehicle slope. The environment 100 includes a vehicle 102 including a slope system 116. In the example of FIG. 1, the vehicle 102 is a tractor-trailer including a tractor 104 and a trailer 106. In various other examples, the vehicle 102 does not include a trailer 106 and may be, for example, a dump truck, a bus, or any other similar vehicle. Also, in some examples, the vehicle 102 is a passenger vehicle, such as a car. In the example of FIG. 1, the vehicle 102 includes a cab 108 where a driver or human user may be positioned.

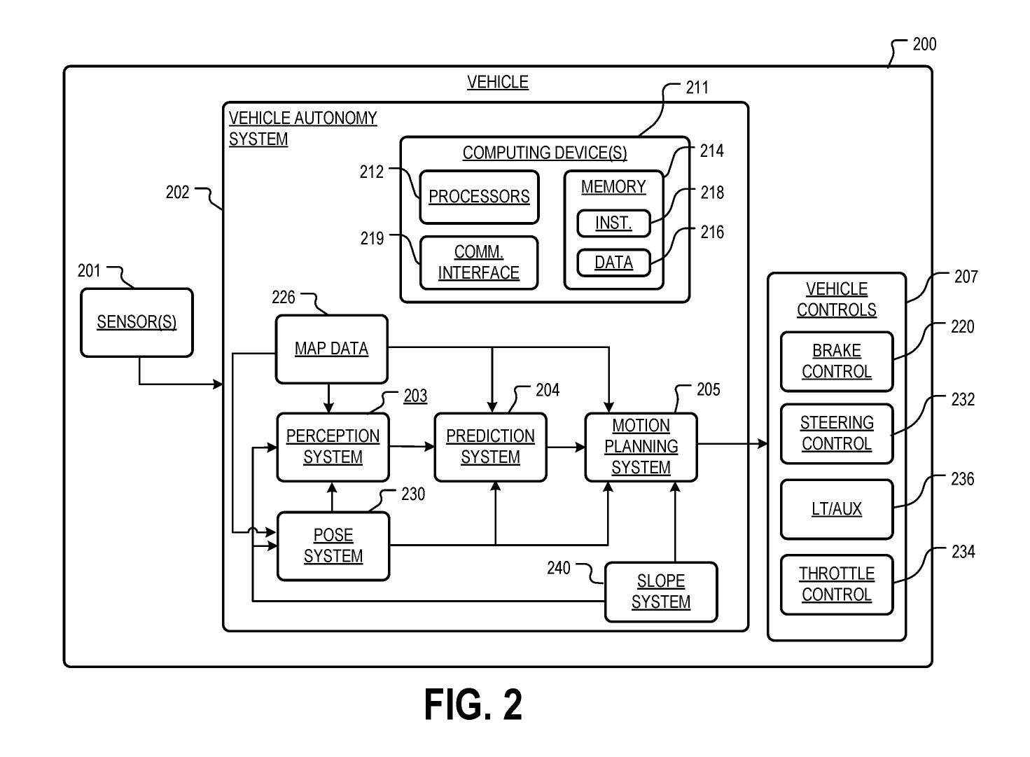

The vehicle 102 is a self-driving vehicle (SDV) or autonomous vehicle (AV). A vehicle autonomy system 118, for example, is configured to operate some or all of the controls of the vehicle 102 (e.g., acceleration, braking, steering). In some examples, the slope system 116 is a component of the vehicle autonomy system 118. The vehicle autonomy system 118, in some examples, is operable in different modes in which the vehicle autonomy system 118 has differing levels of control over the vehicle 102. In some examples, the vehicle autonomy system 118 is operable in a full autonomous mode in which the vehicle autonomy system 118 assumes responsibility for all or most of the controls of the vehicle 102. In addition to or instead of the full autonomous mode, the vehicle autonomy system 118, in some examples, is operable in a semi-autonomous mode in which a human user or driver is responsible for some or all of the control of the vehicle 102. Additional details of an example vehicle autonomy system are provided in FIG. 2.

The vehicle 102 has one or more remote-detection sensors 112 that receive return signals from the environment 100. Return signals may be reflected from objects in the environment 100, such as the ground, buildings, trees, etc. The remote-detection sensors 112 may include one or more active sensors, such as LIDAR, RADAR, and/or SONAR that emit sound or electromagnetic radiation in the form of light or radio waves to generate return signals. The remote-detection sensors 112 may also include one or more passive sensors, such as cameras or other imaging sensors, proximity sensors, etc., that receive return signals that originated from other sources of sound or electromagnetic radiation. Information about the environment 100 is extracted from the return signals. In some examples, the remote-detection sensors 112 include one or more passive sensors that receive reflected ambient light or other radiation, such as a set of monoscopic or stereoscopic cameras. Remote-detection sensors 112 provide remote sensor data that describes the environment 100.

In FIG. 1, the vehicle 102 is under deceleration, which causes the cab 108 to tilt 114 forward to the position 108T. Also, in the example of FIG. 1, the remote-detection sensors 112 are mounted on the cab 108. Accordingly, when the cab 108 tilts to the position 108T, the remote-detection sensors 112 similarly tilt to the position 112T. As shown, this tilts the remote-detection sensors 112 towards the ground, which may cause the ground to appear in the sensors' 112 field-of-view. The example of FIG. 1 shows the vehicle 102 under deceleration, which causes the cab 108 to be tilted towards the vehicle's 102 front (positions 108T, 112T). Cab tilt 114 may also occur towards the rear of the vehicle 102 (e.g., towards the trailer 106, opposite of what is shown in FIG. 1). Cab tilt 114 towards the rear of the vehicle 102 can occur, for example, when the vehicle 102 is under acceleration.

FIG. 1 also shows the slope system 116. As described herein, the slope system 116 determines a cab independent slope 122 of the vehicle 102 and a cab-referenced slope 124 of the vehicle 102. In the example of FIG. 1, the vehicle 102 is on a negative or downhill slope. Accordingly, in this example, both the cab dependent slope 124 and cab independent slope 122 are negative. The slope system 116 determines a difference 142 between the cab-independent slope 122 and the cab-referenced slope 124, which gives the cab tilt 114. The cab tilt 114 is provided to the vehicle autonomy system 118. The vehicle autonomy system 118 utilizes the cab tilt 114, for example, to change the way that it processes signals from remote-detection sensors 112, for example, to generate a pose (e.g., position and attitude) for the vehicle 102, to detect objects in the vehicle's environment 100, etc.

The slope system 116 can determine the cab-independent slope 122 and cab-referenced slope 124 based on different inputs. In some examples, the slope system 116 receives a pose from the vehicle autonomy system 118 (e.g., a pose system thereof, FIG. 2). The pose indicates a position and an attitude of the vehicle 102. Additional description of a vehicle pose is provided below with respect to FIG. 2. The slope system 116, in some examples, also receives sensor signals from one or more slope sensors 120. The slope sensors 120 include any suitable sensor that directly or indirectly measures the slope of the vehicle 102. For example, an inclinometer measures a slope for the vehicle 102 relative to where it is mounted. That is, an inclinometer mounted in the cab 108 measures a cab-referenced slope. An inclinometer mounted on the chassis 110 measures a cab-independent slope. Other example slope sensors 120 include one or more altimeters, one or more barometers, one or more gyroscopic sensors, one or more accelerometers, etc.

In some examples, the slope system 116 and/or slope sensors 120 provide data to the vehicle autonomy system 118 that improves the operation of the vehicle autonomy system 118. For example, the slope sensors 120 may send one or more slope sensor signals to the vehicle autonomy system 118. The vehicle autonomy system 118 uses the slope sensor signals, for example, to improve the accuracy of vehicle poses. Also, in some examples, the slope system 116 provides one or more slopes to the vehicle autonomy system 118. Slopes provided to the vehicle autonomy system 118 could include cab-independent slopes 122 and/or cab-referenced slopes 124. The vehicle autonomy system 118 uses the received slopes, for example, to increase the accuracy of vehicle poses and/or to increase the accuracy of throttle commands sent to an engine or other propulsion unit of the vehicle 102.

FIG. 2 depicts a block diagram of an example vehicle 200 according to example aspects of the present disclosure. Vehicle 200 can be an autonomous or semi-autonomous vehicle. The vehicle 200 includes one or more sensors 201, a vehicle autonomy system 202, and one or more vehicle controls 207. In some examples, the vehicle 200 includes a slope system 240, which may operate in a manner similar to that of the slope system 116 described in FIG. 1.

The vehicle autonomy system 202 can be engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate motion path through the environment. The vehicle autonomy system 202 can control the one or more vehicle controls 207 to operate the vehicle 200 according to the motion path.

The vehicle autonomy system 202 includes a perception system 203, a prediction system 204, a motion planning system 205, and a pose system 230 that cooperate to perceive the surrounding environment of the vehicle 200 and determine a motion plan for controlling the motion of the vehicle 200 accordingly. The pose system 230 may be arranged to operate as described herein.

Various portions of the vehicle autonomy system 202 receive sensor data from the one or more sensors 201. For example, the sensors 201 may include remote-detection sensors as well as motion sensors such as an inertial measurement unit (IMU), one or more encoders, one or more odometers, etc. The sensor data can include information that describes the location of objects within the surrounding environment of the vehicle 200, information that describes the motion of the vehicle 200, etc.

The sensors 201 may also include one or more remote-detection sensors or sensor systems, such as a LIDAR, a RADAR, one or more cameras, etc. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system can measure distances by measuring the Time of Flight (TOF) that it takes a short laser pulse to travel from the sensor to an object and back, calculating the distance from the known speed of light.

As another example, for a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system can reflect off an object and return to a receiver of the RADAR system, giving information about the object's location and speed. Thus, a RADAR system can provide useful information about the current speed of an object.

As yet another example, one or more cameras of the one or more sensors 201 may generate sensor data (e.g., remote sensor data) including still or moving images. Various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system can determine a current position of the vehicle 200. The positioning system can be any device or circuitry for analyzing the position of the vehicle 200. For example, the positioning system can determine a position by using one or more of inertial sensors, a satellite positioning system such as a Global Positioning System (GPS), based on IP address, by using triangulation and/or proximity to network access points or other network components (e.g., cellular towers, WiFi access points, etc.) and/or other suitable techniques. The position of the vehicle 200 can be used by various systems of the vehicle autonomy system 202.

Thus, the one or more sensors 201 can be used to collect sensor data that includes information that describes the location (e.g., in three-dimensional space relative to the vehicle 200) of points that correspond to objects within the surrounding environment of the vehicle 200. In some implementations, the sensors 201 can be located at various different locations on the vehicle 200. As an example, in some implementations, one or more cameras and/or LIDAR sensors can be located in a pod or other structure that is mounted on a roof of the vehicle 200 while one or more RADAR sensors can be located in or behind the front and/or rear bumper(s) or body panel(s) of the vehicle 200. As another example, camera(s) can be located at the front or rear bumper(s) of the vehicle 200. Other locations can be used as well.

The pose system 230 receives some or all of the sensor data from sensors 201 and generates vehicle poses for the vehicle 200. A vehicle pose describes the position and attitude of the vehicle 200. The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a slope about a first horizontal axis and a roll about a second horizontal axis. In some examples, the pose system 230 generates vehicle poses periodically (e.g., every second, every half second, etc.). The pose system 230 appends time stamps to vehicle poses, where the time stamp for a pose indicates the point in time that is described by the pose. The pose system 230 generates vehicle poses by comparing sensor data (e.g., remote sensor data) to map data 226 describing the surrounding environment of the vehicle 200.

In some examples, the pose system 230 includes one or more localizers and a pose filter. Localizers generate pose estimates by comparing remote-sensor data (e.g., LIDAR, RADAR, etc.) to map data. The pose filter receives pose estimates from the one or more localizers as well as other sensor data such as, for example, motion sensor data from an IMU, encoder, odometer, etc. In some examples, the pose filter executes a Kalman filter or machine learning algorithm to combine pose estimates from the one or more localizers with motion sensor data to generate vehicle poses. In some examples, localizers generate pose estimates at a frequency less than the frequency at which the pose system 230 generates vehicle poses. Accordingly, the pose filter generates some vehicle poses by extrapolating from a previous pose estimate utilizing motion sensor data.

The perception system 203 detects objects in the surrounding environment of the vehicle 200 based on sensor data, map data 226 and/or vehicle poses provided by the pose system 230. Map data 226, for example, may provide detailed information about the surrounding environment of the vehicle 200. The map data 226 can provide information regarding: the identity and location of different roadways, segments of roadways, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway; traffic control data (e.g., the location and instructions of signage, traffic lights, or other traffic control devices); and/or any other map data that provides information that assists the vehicle autonomy system 202 in comprehending and perceiving its surrounding environment and its relationship thereto. A roadway may be a place where the vehicle can drive and may include, for example, a road, a street, a highway, a lane, a parking lot, a driveway, etc. The perception system 203 may utilize vehicle poses provided by the pose system 230 to place the vehicle 200 within the map data and thereby predict which objects should be in the vehicle 200's surrounding environment.

In some examples, the perception system 203 determines state data for one or more of the objects in the surrounding environment of the vehicle 200. State data may describe a current state of an object (also referred to as features of the object). The state data for each object describes, for example, an estimate of the object's: current location (also referred to as position); current speed (also referred to as velocity); current acceleration; current heading; current orientation; size/shape/footprint (e.g., as represented by a bounding shape such as a bounding polygon or polyhedron); type/class (e.g., vehicle versus pedestrian versus bicycle versus other); yaw rate; distance from the vehicle 200; minimum path to interaction with the vehicle 200; minimum time duration to interaction with the vehicle 200; and/or other state information.

In some implementations, the perception system 203 can determine state data for each object over a number of iterations. In particular, the perception system 203 can update the state data for each object at each iteration. Thus, the perception system 203 can detect and track objects, such as vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 can generate prediction data associated with one or more of the objects detected by the perception system 203. In some examples, the prediction system 204 generates prediction data describing each of the respective objects detected by the prediction system 204.

Prediction data for an object can be indicative of one or more predicted future locations of the object. For example, the prediction system 204 may predict where the object will be located within the next 5 seconds, 20 seconds, 200 seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the pose system 230 and/or map data 226.

In some examples, the prediction system 204 uses state data indicative of an object type or classification to predict a trajectory for the object. As an example, the prediction system 204 can use state data provided by the perception system 203 to determine that particular object (e.g., an object classified as a vehicle) approaching an intersection and maneuvering into a left-turn lane intends to turn left. In such a situation, the prediction system 204 can predict a trajectory (e.g., path) corresponding to a left-turn for the vehicle 200 such that the vehicle 200 turns left at the intersection. Similarly, the prediction system 204 can determine predicted trajectories for other objects, such as bicycles, pedestrians, parked vehicles, etc. The prediction system 204 can provide the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 determines a motion plan for the vehicle 200 based at least in part on the predicted trajectories associated with the objects within the surrounding environment of the vehicle 200, the state data for the objects provided by the perception system 203, vehicle poses provided by the pose system 230, and/or map data 226. Stated differently, given information about the current locations of objects and/or predicted trajectories of objects within the surrounding environment of the vehicle 200, the motion planning system 205 can determine a motion plan for the vehicle 200 that best navigates the vehicle 200 relative to the objects at such locations and their predicted trajectories on acceptable roadways.

In some implementations, the motion planning system 205 can evaluate one or more cost functions and/or one or more reward functions for each of one or more candidate motion plans for the vehicle 200. For example, the cost function(s) can describe a cost (e.g., over time) of adhering to a particular candidate motion plan while the reward function(s) can describe a reward for adhering to the particular candidate motion plan. For example, the reward can be of a sign opposite to the cost.

Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate pathway. The motion planning system 205 can select or determine a motion plan for the vehicle 200 based at least in part on the cost function(s) and the reward function(s). For example, the motion plan that minimizes the total cost can be selected or otherwise determined. The motion plan can be, for example, a path along which the vehicle 200 will travel in one or more forthcoming time periods. In some implementations, the motion planning system 205 can be configured to iteratively update the motion plan for the vehicle 200 as new sensor data is obtained from one or more sensors 201. For example, as new sensor data is obtained from one or more sensors 201, the sensor data can be analyzed by the perception system 203, the prediction system 204, and the motion planning system 205 to determine the motion plan.

Each of the perception system 203, the prediction system 204, the motion planning system 205, and the pose system 230, can be included in or otherwise a part of a vehicle autonomy system 202 configured to determine a motion plan based at least in part on data obtained from one or more sensors 201. For example, data obtained by one or more sensors 201 can be analyzed by each of the perception system 203, the prediction system 204, and the motion planning system 205 in a consecutive fashion in order to develop the motion plan. While FIG. 2 depicts elements suitable for use in a vehicle autonomy system according to example aspects of the present disclosure, one of ordinary skill in the art will recognize that other vehicle autonomy systems can be configured to determine a motion plan for an autonomous vehicle based on sensor data.

The motion planning system 205 can provide the motion plan to one or more vehicle controls 207 to execute the motion plan. For example, the one or more vehicle controls 207 can include throttle systems, brake systems, steering systems, and other control systems, each of which can include various vehicle controls (e.g., actuators or other devices that control gas flow, steering, braking, etc.) to control the motion of the vehicle 200. The various vehicle controls 207 can include one or more controllers, control devices, motors, and/or processors.

The vehicle controls 207 can include a brake control module 220. The brake control module 220 is configured to receive all or part of the motion plan and generate a braking command that applies (or does not apply) the vehicle brakes. In some examples, the brake control module 220 includes a primary system and a secondary system. The primary system may receive braking commands and, in response, brake the vehicle 200. The secondary system may be configured to determine a failure of the primary system to brake the vehicle 200 in response to receiving the braking command.

A steering control system 232 is configured to receive all or part of the motion plan and generate a steering command. The steering command is provided to a steering system to provide a steering input to steer the vehicle 200. A lighting/auxiliary control module 236 may receive a lighting or auxiliary command. In response, the lighting/auxiliary control module 236 may control a lighting and/or auxiliary system of the vehicle 200. Controlling a lighting system may include, for example, turning on, turning off, or otherwise modulating headlines, parking lights, running lights, etc. Controlling an auxiliary system may include, for example, modulating windshield wipers, a defroster, etc.

A throttle control system 234 is configured to receive all or part of the motion plan and generate a throttle command. The throttle command is provided to an engine and/or engine controller, or other propulsion system component to control the engine or other propulsion system of the vehicle 200. The slope system 240 operates in conjunction with the throttle control system 234 as described herein, to generate a throttle command.

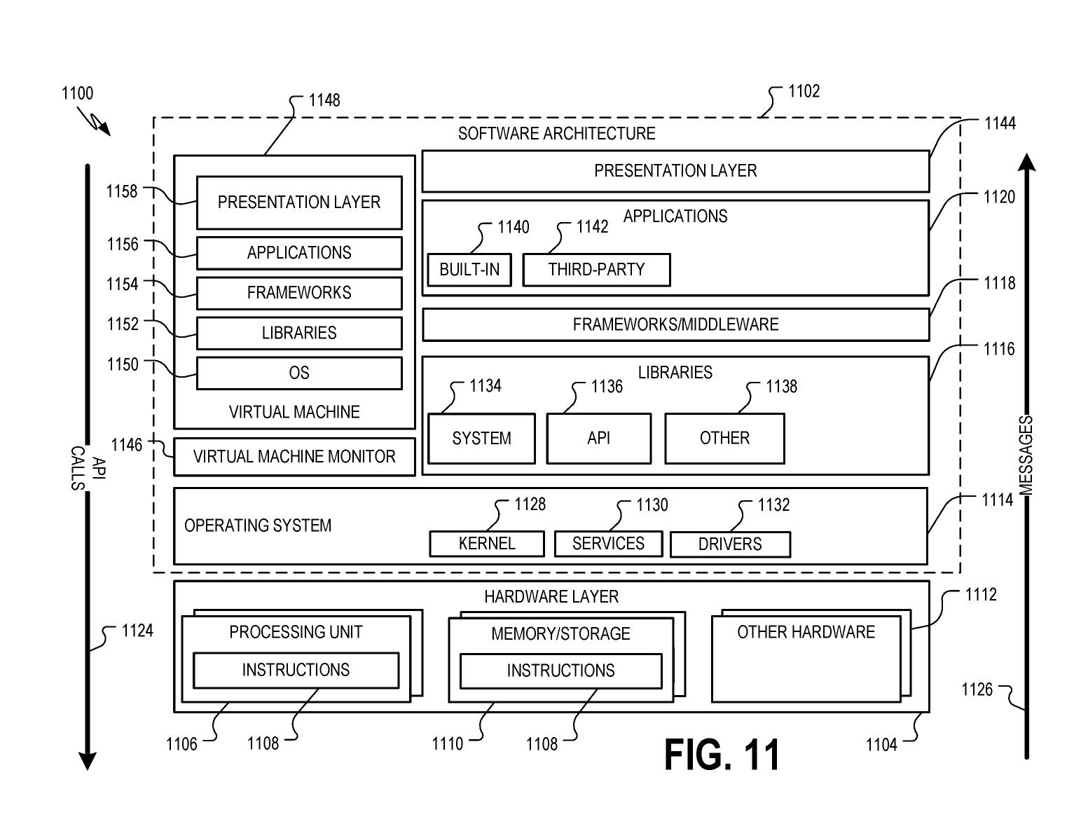

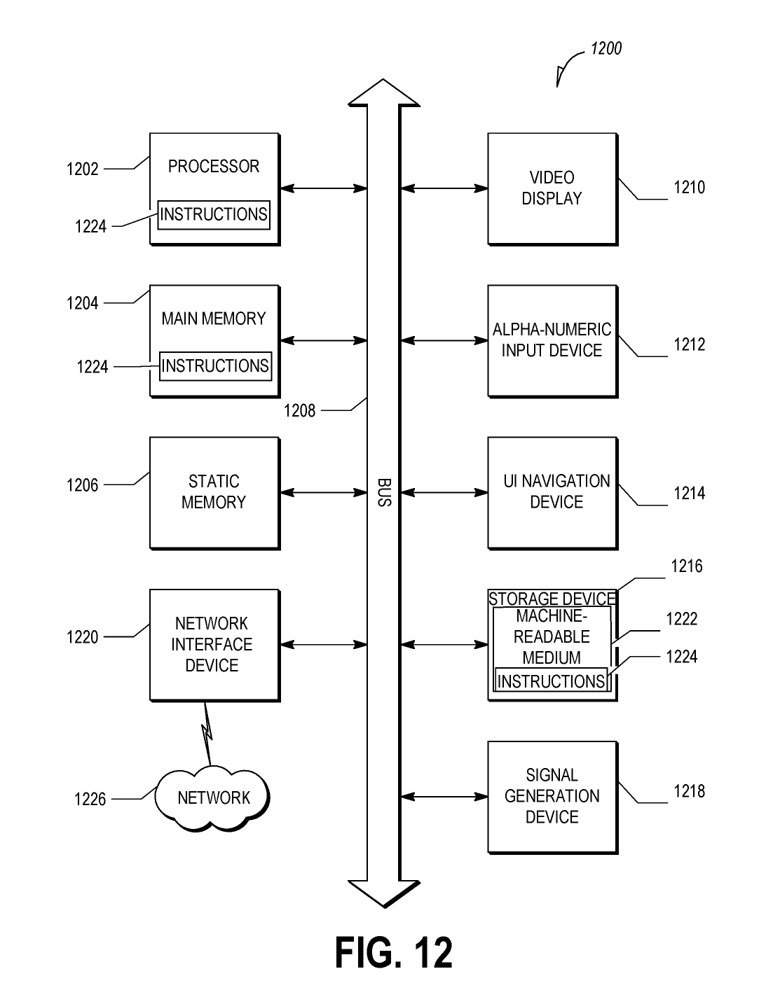

The vehicle autonomy system 202 includes one or more computing devices, such as the computing device 211, which may implement all or parts of the perception system 203, the prediction system 204, the motion planning system 205 and/or the pose system 230. The example computing device 211 can include one or more processors 212 and one or more memory devices (collectively referred to as memory) 214. The one or more processors 212 can be any suitable processing device (e.g., a processor core, a microprocessor, an Application Specific Integrated Circuit (ASIC), a Field Programmable Gate Array (FPGA), a microcontroller, etc.) and can be one processor or a plurality of processors that are operatively connected. The memory 214 can include one or more non-transitory computer-readable storage mediums, such as Random Access Memory (RAM), Read Only Memory (ROM), Electrically Erasable Programmable Read Only Memory (EEPROM), Erasable Programmable Read Only Memory (EPROM), flash memory devices, magnetic disks, etc., and combinations thereof. The memory 214 can store data 216 and instructions 218 which can be executed by the processor 212 to cause the vehicle autonomy system 202 to perform operations. The one or more computing devices 211 can also include a communication interface 219, which can allow the one or more computing devices 211 to communicate with other components of the vehicle 200 or external computing systems, such as via one or more wired or wireless networks. Additional descriptions of hardware and software configurations for computing devices, such as the computing device(s) 211 are provided herein at FIGS. 11 and 12.

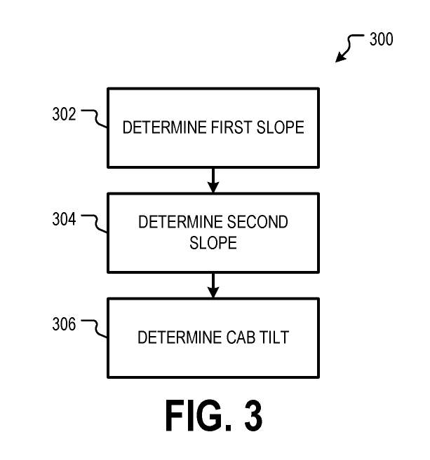

FIG. 3 is a flowchart showing one example of a process flow 300 that may be executed by a slope system to determine cab tilt. The process flow 300 may be executed, for example, by a slope system of an AV, such as the slope system 116 or the slope system 240 described herein.

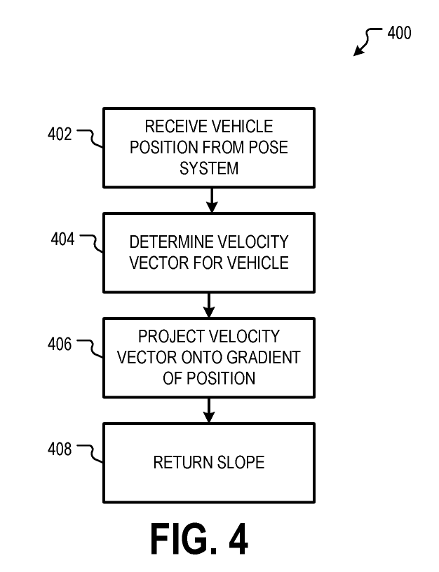

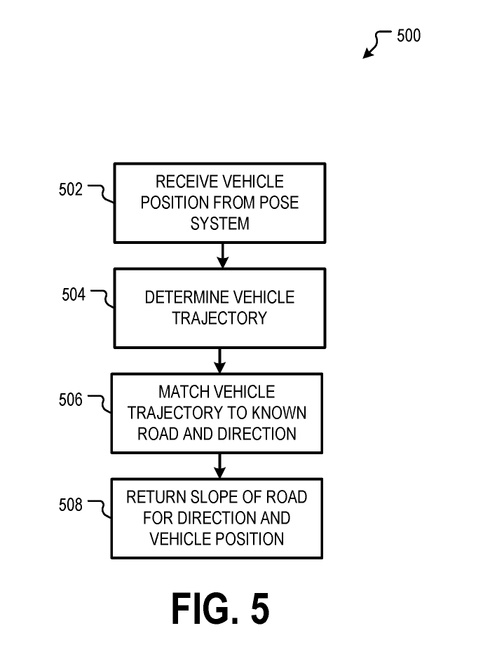

At operation 302, the slope system determines a first slope describing the vehicle. The first slope is independent of the cab. The first slope may be determined, for example, from a vehicle pose determined by a pose system. For example, the slope system may receive a vehicle pose indicating the vehicle's current position. In another example, the slope system accesses map data. From the map data, the slope system determines the slope at the current location of the vehicle, in the vehicle's direction of travel. In another example, the first slope is determined by accessing a vehicle slope indicated by a vehicle pose. Also, in some examples, the first slope is determined using an inclinometer or other suitable sensor mounted to the frame or other component of the vehicle that does not tilt with the cab. Additional examples describing how the slope system can determine a cab-independent slope are provided herein, for example, with respect to FIGS. 4 and 5.

At operation 304, the slope system determines a second slope that is dependent on the cab. The cab-dependent second slope may be determined, for example, from an inclinometer or other sensor that is mounted to or in the cab. At operation 306, the slope system determines cab tilt, for example, by finding a difference between the cab-independent first slope and the cab-dependent second slope.

FIG. 4 is a flowchart showing one example of a process flow 400 that may be executed by a slope system to determine an example cab-independent slope for a vehicle. In the example of FIG. 4, the slope system receives a vehicle position from the pose system (e.g., as part of a vehicle pose). The slope system also receives and/or determines a velocity vector indicating a direction of travel for the vehicle. The slope system projects the velocity vector (e.g., a normalized version of the velocity vector) onto a gradient of the position, where the gradient of the position is indicated by a map. The result is a cab-independent slope.

At operation 402, the slope system receives a vehicle position from the pose system. In some examples, the vehicle position is part of a vehicle pose that indicates the vehicle's position and attitude.

At operation 404, the slope system determines a velocity vector for the vehicle. The velocity vector indicates a vehicle speed and a vehicle direction. The velocity vector may be determined in any suitable manner. For example, the vehicle's velocity may be determined from motion sensors, such as an IMU, from a global positioning system (GPS) sensor, etc. In some examples, the velocity vector is determined, at least in part, from the vehicle pose. For example, a vehicle attitude may have a direction equal to the direction of the velocity vector. For example, the vehicle attitude projected onto a horizontal plane may be equivalent to the velocity vector of the vehicle relative to a flat map.

At operation 406, the slope system projects the velocity vector onto map data to determine the vehicle slope. The map data may include directionally-dependent gradient data. For example, the gradient at any given point described by the map data depends on the direction in which the vehicle is traveling. For example, consider a point on a hill. If the vehicle is at the point and traveling uphill, then the gradient is positive. If the vehicle is at the point and traveling downhill, then the gradient is negative. Similarly, if the vehicle is traveling in a direction between directly uphill and directly downhill, the gradient may take different values. Projecting the velocity vector onto the map data includes determining the gradient at the vehicle's location considering the direction-of-travel indicated by the velocity vector.

In some examples, projecting the velocity vector onto the map data includes determining a series of points described by the map data that are in-line with the velocity vector. The series of points may include the vehicle's current position. The vehicle's slope may be determined based on the change in elevation of the series of points and the distance between the points.

FIG. 5 is a flowchart showing one example of a process flow 500 that may be executed by a slope system to determine a cab-independent slope for a vehicle. In the example of FIG. 5, the slope system receives a vehicle position from the pose system (e.g., as part of a vehicle pose). The slope system determines a vehicle trajectory, where the trajectory indicates a direction of travel. For example, the trajectory may indicate a cardinal direction, heading, etc. The slope system matches the trajectory and position to a known roadway. The slope of the vehicle is the slope of the known roadway at the indicated position and direction of travel.

At operation 502, the slope system receives vehicle pose data. The vehicle pose data may include a vehicle position and may also include a vehicle attitude. At operation 504, the slope system determines a vehicle trajectory. The vehicle trajectory may be or include a direction derived from a velocity vector, as described herein. In some examples, the vehicle trajectory can also be determined from a compass or other direction sensor.

At operation 506, the slope system matches the vehicle trajectory and position to a known roadway and direction. For example, if the vehicle's position is on Interstate 80 and the vehicle trajectory is west, the slope system may determine that the vehicle is west-bound on Interstate 80. At operation 508, the slope system returns the slope of the identified roadway at the vehicle's position.

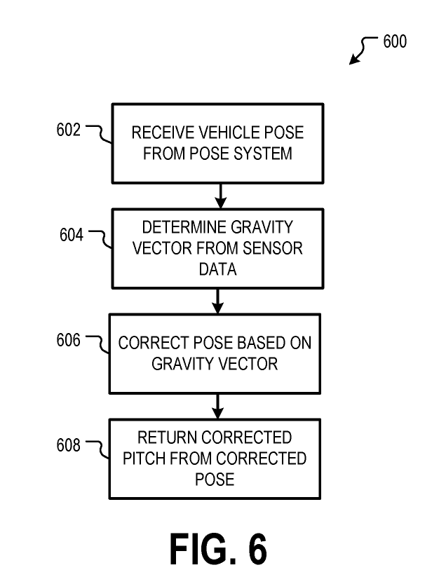

FIG. 6 is a flowchart showing one example of a process flow 600 that may be executed by a slope system to determine an example cab-independent slope for a vehicle from a vehicle pose. The vehicle pose, as described herein, may include a vehicle position and attitude. The attitude includes a vehicle slope referenced to a pose reference frame. In various examples, the accuracy of the slope included with the vehicle pose can be improved. The process flow 600 shows one example way that the slope from the vehicle pose can be improved utilizing a measured gravity vector.

At operation 602, the slope system receives the vehicle pose from the pose system. At operation 604, the slope system determines a gravity vector from sensor data. The gravity vector is a vector indicating the force of gravity on the vehicle. The gravity vector direction is down (e.g., towards the center of the earth). The gravity vector may be determined, for example, using an inclinometer or any other suitable sensor. The gravity vector defines a measured reference frame. For example, in the measured reference frame, the gravity vector is pointed in the direction of the negative z-axis.

At operation 606, the slope system corrects the received pose using the gravity vector. The received pose includes a slope for the vehicle that is referenced to the pose reference frame, which can be expressed using any suitable coordinate system. The pose reference frame is based on matching map data with remote sensor data, as described herein. The slope system corrects the received pose by positioning the slope of the received pose on the measured reference frame, indicated by the gravity vector determined at operation 604.

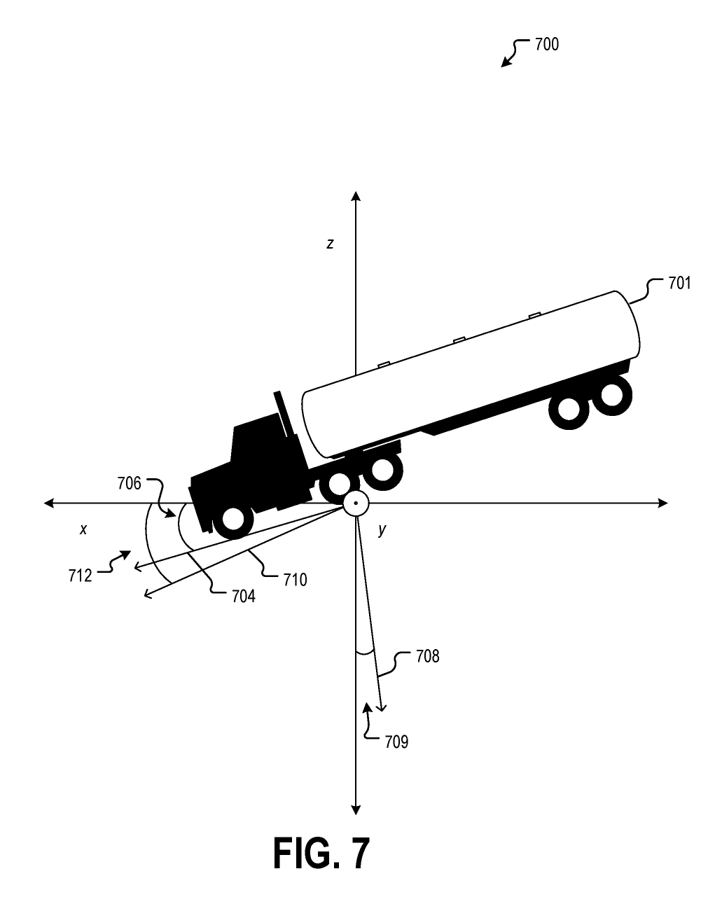

For example, the slope included with the received pose (the pose slope) can be or include an angle relative to a vertical axis of the pose reference frame. The slope system determines a difference between a pose reference frame gravity direction and the measured direction of the gravity vector. For reference, in the example of FIG. 7 described below, the pose reference frame gravity direction is the negative z-axis and the measured direction of the gravity vector is indicated by gravity vector 708.

If the pose reference frame gravity direction deviates from the direction of the gravity vector, then the slope system corrects the pose slope by expressing the pose slope relative to the measured reference frame. This can include shifting the pose slope by an amount equal to the difference between the pose reference frame gravity direction and the measured gravity direction. This can also include holding the pose slope constant while shifting the pose reference frame to align with the measured reference frame indicated by the gravity vector.

At operation 608, the slope system returns the adjusted slope from the corrected pose. The adjusted slope provides a cab-independent slope measurement that may be used to determine cab tilt as described herein. Also, in some examples, an adjusted vehicle pose, including the adjusted pitch angle, is used by the vehicle autonomy system to perform various processing for controlling the vehicle. This may include, for example, determining future vehicle poses, determining vehicle motion plans and corresponding control commands, etc.

FIG. 7 is a diagram 700 showing an example pose system slope and adjusted slope for a vehicle. The diagram 700 illustrates one way that the slope system can generate a cab-independent slope as described by the process flow 600. In this example, a vehicle pose describing a vehicle 701 includes a slope. The vehicle pose is referenced to a pose reference frame described by a reference coordinate system represented in FIG. 7 by a set of axes: x, y, and z. The x-axis (left to right in FIG. 7) and y-axis (out of the page in FIG. 7) indicate horizontal. The z-axis indicates vertical. The slope is indicated by slope vector 704 and slope angle 706.

Ideally, the negative z-axis is directed down in the direction of gravity and aligns with the measured gravity vector. In practice, however, inaccuracies in the pose estimate can cause the pose reference frame to deviate slightly from the actual environment of the vehicle. FIG. 7 also shows a measured gravity vector 708 that deviates from the negative z-axis as shown. The gravity vector 708 may be measured in any suitable manner such as, for example, with an inclinometer. The slope system generates a vehicle slope by correcting the pose (e.g., the attitude of the pose) in view of the measured gravity vector 708. In the example of FIG. 7, the gravity vector 708 deviates from the negative z-axis in the x-z plane by an angle 709. Accordingly, to find the adjusted slope, the slope system rotates the slope vector 704 in the x-z plane by an angle equal to the angle 709 to generate the adjusted slope vector 710 with adjusted slope angle 712.

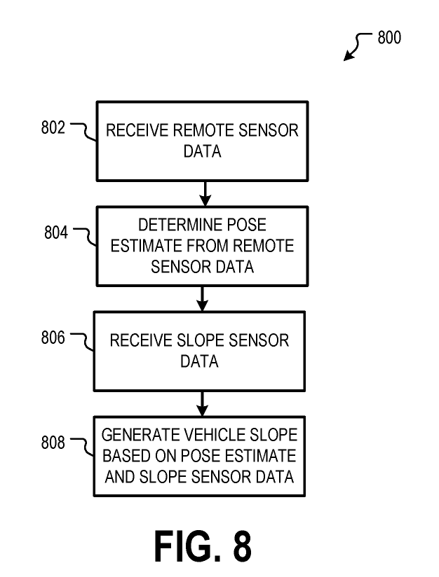

In some examples, slope sensor data is also be provided back to the pose system. For example, a pose filter of the pose system considers the slope sensor data as a factor in its Kalman filter or other suitable machine learning processing. In some examples, this improves the accuracy of the pitch included with the pose estimate. FIG. 8 is a flowchart showing one example of a process flow 800 that may be executed by a vehicle autonomy system, such as a slope system and/or pose system thereof, to generate a vehicle slope based on a pose estimate and on slope sensor data.

At operation 802, the vehicle autonomy system receives remote sensor data. The remote sensor data may include, for data from a remote-detection sensor such as, for example, a LIDAR, a RADAR, one or more cameras, etc. At operation 804, the vehicle autonomy system determines a pose estimate from the remote sensor data. For example, a localizer of a pose system may match the remote sensor data to map data. For example, the map data may indicate the position and orientation of various objects. The remote sensor data describes objects that are sensed in the vehicle's environment. The localizer matches the position and orientation of the sensed objects to the objects indicated on the map to generate the pose estimate. The localizer may generate the pose estimate using a Kalman filter, a machine learning algorithm, or other suitable algorithm. In some examples, a pose filter receives the pose estimate and generates the vehicle pose considering the pose estimate and motion sensor data, such as from an IMU.

At operation 806, the vehicle autonomy system receives slope sensor data. The slope sensor data may be received from any suitable sensor such as, for example, an inclinometer, gyroscopic sensor, accelerometer, etc. At operation 808, the vehicle autonomy system (e.g., the pose system and/or the slope system) generates a vehicle slope based on the pose estimate and the slope sensor data. For example, the machine learning algorithm may receive as input one or more poses generated by the pose system as well as the output of one or more slope sensors. The vehicle autonomy may execute a Kalman filter, machine learning algorithm, or other suitable algorithm to determine the vehicle slope in view of the measured slope sensor data. The slope generated according to the process flow 800, in some examples, is cab-independent slope.

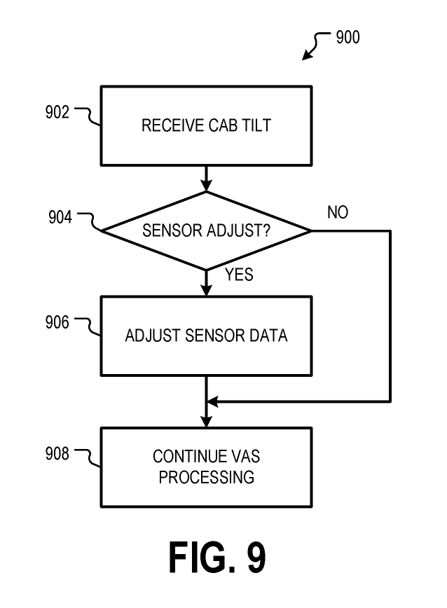

FIG. 9 is flowchart showing one example of a process flow 900 that may be executed by a vehicle autonomy system (e.g., a pose system and/or perception system thereof) to adjust sensor data in view of detected cab tilt. For example, the vehicle autonomy system may determine, in the presence of cab tilt, that one or more sensor outputs have been corrupted by cab tilt. In some examples, correction occurs when cab tilt is detected (e.g., above a threshold level). In other examples, correction occurs when cab tilt is detected and an anomaly is detected in a sensor output (e.g., if a LIDAR sensor system return indicates the road is in its field-of-view).

At operation 902, the vehicle autonomy system receives cab tilt data describing a cab tilt for the vehicle. The cab tilt may be determined in any suitable manner including, for example, as described herein with respect to FIGS. 1 and 3.

At operation 904, the vehicle autonomy system determines if remote sensor data is to be adjusted for cab tilt. For example, when the cab of the vehicle tilts, the field-of-view of one or more cab-mounted remote-detection sensors may include portions of the ground or the sky. The vehicle autonomy system determines if the remote sensor data is to be adjusted for cab tilt based on the cab tilt data and/or the remote sensor data.

In some examples, determining whether to adjust remote sensor data for cab tilt includes determining whether a road surface is in a field-of-view of a LIDAR or other remote detection sensors. For example, the vehicle autonomy system analyzes remote sensor data to identify data indicating an object within a threshold distance of a front of the vehicle. Such an object may be detected, for example, when return signals from the vehicle's environment are reflected by a surface positioned in front of the vehicle. In the absence of cab tilt, the presence of such a surface may indicate that an object is in front of the vehicle. If the vehicle's cab is tilting forwards, as illustrated in FIG. 1, however, the surface may be the road surface itself. To determine if the surface is an object or the road surface, the vehicle autonomy system accesses the cab tilt data. If the cab tilt data indicates that the cab is tilted forward by more than a cab tilt threshold, the vehicle autonomy system determines that the road surface is in the sensor field-of-view and, accordingly, determines to correct the remote sensor data. If the cab tilt is not above the cab tilt threshold, the vehicle autonomy system processes the detected surface as an object and causes the vehicle to react accordingly (e.g., apply the brakes, steer around the object, etc.).

In another example, the vehicle autonomy system determines to adjust remote sensor data based on the cab tilt data. For example, if the cab tilt data is above a threshold, then the vehicle autonomy system adjusts the remote sensor data. If the vehicle autonomy system determines that no sensor data adjustment is called for, the vehicle autonomy system continues its processing at operation 908.

If the vehicle autonomy system determines that sensor data is to be adjusted, it adjusts the remote sensor data at operation 906. The vehicle autonomy system corrects the sensor data, for example, by screening portions of the range of the sensor data that are outside the intended field-of-view. For example, the vehicle autonomy system can correct for sensor data that unintentionally indicates a road by screening the portion of the sensor data that includes the road. Also, in some examples, the vehicle autonomy system shifts the sensor data. For example, if the cab is tilted forward by a given angle, the vehicle autonomy system may shift data points included in the remote sensor data back by a corresponding angle. Similarly, if the cab is tilted back by a given angle, the vehicle autonomy system may shift data points included in the remote sensor data forward by a corresponding angle.

Corrected remote sensor data generated at operation 906 may be used by the vehicle autonomy system in any suitable manner. For example, the corrected remote sensor data may be used to detect objects, such as cars, pedestrians, etc., in the vehicle's environment and make appropriate commands to the vehicle's controls. Also, the corrected remote sensor data may be used to generate a vehicle pose, as described herein.

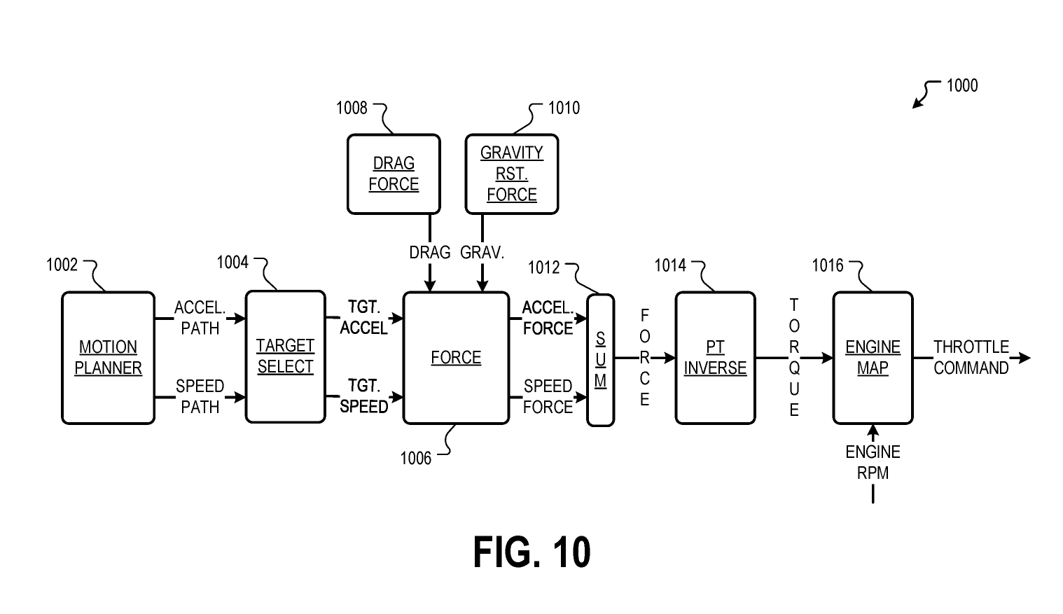

FIG. 10 is a diagram showing an example workflow 1000 that may be executed, for example, by a throttle command system and/or motion planner of an AV to modify a throttle command in view of a slope measurement, for example, made by a slope system as described herein. In the example of FIG. 10, a throttle command provided to an engine controller of the vehicle is modified to adjust for the vehicle slope. For example, if the vehicle is traveling up a hill, more throttle is required to achieve a desired speed or acceleration than if the vehicle is on a flat surface or traveling downhill. Similarly, if the vehicle is traveling downhill, less throttle is required to achieve a desired speed or acceleration.

In FIG. 10, a motion planning operation 1002 generates a motion plan that includes an acceleration path and a speed path. The acceleration path describes a desired acceleration of the vehicle and the speed path describes a desired speed of the vehicle. (A motion plan may also include other data, such as a direction path indicating a desired direction for the vehicle.) The acceleration and speed path may be expressed over time. For example, the acceleration path be or include a function expressing an acceleration of the vehicle as a function of time, as given by Equation [1] below:

accel_path(t) [1]

Similarly, the speed path may be or include a function expressing a speed of the vehicle as a function of time, as given by Equation [2] below:

speed_path(t) [2]

In Equations [1] and [2], t is time. The motion planning operation 1002 may be performed by the vehicle autonomy system, such as, for example, by a motion planning system of the vehicle autonomy system.

A selection operation 1004 generates a target speed and target acceleration for the vehicle. This may include evaluating the acceleration path and/or speed path for a value for the current time (e.g., the time at which the calculation is being performed). The selection operation 1004 may be performed by the vehicle autonomy system such as, for example, by a motion planning system and/or by a throttle control system.

An example target acceleration is given by Equation [3] below:

accel_path(now) [3]

Equation [3] is an evaluation of the acceleration path of Equation [1] for the time t=now, where now is the current time. Similarly, an example target speed is given by Equation [4] below:

speed_path(now) [4]

Equation [4] is an evaluation of the speed path of Equation [2] for the time t=now, again where now is the current time.

In some examples, the target acceleration is generated with a look-ahead time, as given by Equation [5] below:

accel_path(now+t_lookahead) [5]

Equation [5] is an evaluation of the acceleration path of Equation [1] for a time equal to the current time (now) plus a look-ahead time (t_lookahead). The look-ahead time may compensate for throttle lag or other delays between the time that a command is called-for and when the result of the command is translated to the wheels of the vehicle. In some examples, a similar look-ahead time is used for generating the target speed, as given by Equation [6] below:

speed_path(now+t_lookahead) [6]

Equation [6] is an evaluation of the speed path of Equation [2] for a time equal to the current time (now) plus a look-ahead time (t_lookahead). The look-ahead time for the target speed may be the same as the look-ahead time for the target acceleration, or may be different. In some examples, a look-ahead time is used for the target acceleration but not for the target speed. Also, in some examples, a look-ahead time is used for the target speed but not for the target acceleration.

The target acceleration and target speed are provided to a force operation 1006. The force operation 1006 generates an acceleration force and a speed force to be applied to the vehicle to bring about the target speed and target acceleration. The acceleration force and/or speed force may be determined considering a drag force operation 1008 and a gravitational force operation 1010. Operations 1008 and 1010 may be performed by the vehicle autonomy system such as, for example, by the motion planning system and/or throttle correction system. In some examples, all or part of the operations 1008 and 1010 are performed by a throttle control system.

The drag force operation 1008 determines a force exerted on the vehicle due to aerodynamic drag. An example equation for finding aerodynamic drag is given by Equation [7] below:

force_drag=½drag_area×speed² [7]

The gravitational resistance force operation 1010 determines the contribution of gravity to the motion of the vehicle. For example, if the vehicle is traveling downhill, the gravitational force tends to increase the speed and/or acceleration of the vehicle, which may lead to a reduced throttle command. On the other hand, if the vehicle is traveling uphill, the gravitational force tends to decrease the speed and/or acceleration of the vehicle, which may lead to an increased throttle command. An example equation for finding the gravitational force at operation 1010 is given by Equation [8] below:

gravity force=m×g×sin(road_slope) [8]

In Equation [8], m is the mass of the vehicle, g is the force of gravity and road_slope is an angle indicating how much the slope of the road deviates from horizontal. The road slope used to determine the gravitational force may be determined by the vehicle autonomy system and/or other suitable components of the vehicle as described herein.

In some examples, the force operation 1006 utilizes separate speed and acceleration paths to generate the speed force and acceleration force, respectively. For example, the speed path may be a feedback path that receives a measured speed of the vehicle. A controller, such as a Proportional, Integral, Derivative (PID) controller, receives an error signal indicating a difference between the measured speed and the target speed and generates the speed force from the error signal. The acceleration path, in some examples, is a feedforward path that determines the acceleration force based on vehicle properties and conditions such as, for example, the vehicle mass, the drag force determined by drag force operation 1008, and the gravitational force determined by gravitational force operation 1010.

The acceleration force and speed force are summed at a summing operation 1012 to generate a total force to be applied to the vehicle. The summing operation 1012 may be performed by the vehicle autonomy system such as, for example, a throttle correction system and/or by a throttle control system. The total force is provided to a powertrain inverse operation 1014 to generate a target engine torque. The target engine torque is the engine torque level that will generate the desired total force on the vehicle. The powertrain inverse operation 1014 may utilize an inverse model of the powertrain that relates engine torque to force delivered to the vehicle.

The target engine torque is provided to an engine map operation 1016. The engine map operation also receives a current engine speed, for example, in rotations per minute (RPM) and generates the biased throttle command. The engine map operation 1016 utilizes engine map data that relates the target engine torque and the current engine speed to a throttle command to bring about the target engine torque. The resulting throttle command is provided, for example, to an engine controller of the vehicle to modulate the engine throttle. Operations 1014 and 1016 may be performed by the vehicle autonomy system such as, for example, a throttle correction system and/or by a throttle control system.

FIG. 11 is a block diagram 1100 showing one example of a software architecture 1102 for a computing device. The software architecture 1102 may be used in conjunction with various hardware architectures, for example, as described herein. FIG. 11 is merely a non-limiting example of a software architecture 1102 and many other architectures may be implemented to facilitate the functionality described herein. A representative hardware layer 1104 is illustrated and can represent, for example, any of the above-referenced computing devices. In some examples, the hardware layer 1104 may be implemented according to an architecture 1200 of FIG. 12 and/or the architecture 1102 of FIG. 11.

The representative hardware layer 1104 comprises one or more processing units 1106 having associated executable instructions 1108. The executable instructions 1108 represent the executable instructions of the software architecture 1102, including implementation of the methods, modules, components, and so forth of FIGS. 1-10. The hardware layer 1104 also includes memory and/or storage modules 1110, which also have the executable instructions 1108. The hardware layer 1104 may also comprise other hardware 1112, which represents any other hardware of the hardware layer 1104, such as the other hardware illustrated as part of the architecture 1200.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and a presentation layer 1144. Operationally, the applications 1120 and/or other components within the layers may invoke API calls 1124 through the software stack and receive a response, returned values, and so forth illustrated as messages 1126 in response to the API calls 1124. The layers illustrated are representative in nature and not all software architectures have all layers. For example, some mobile or special-purpose operating systems may not provide a frameworks/middleware 1118 layer, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of a hardware or software interrupt and, in response, cause the software architecture 1102 to pause its current processing and execute an ISR when an interrupt is received. The ISR may generate an alert.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), WiFi® drivers, NFC drivers, audio drivers, power management drivers, and so forth depending on the hardware configuration.

The libraries 1116 may provide a common infrastructure that may be used by the applications 1120 and/or other components and/or layers. The libraries 1116 typically provide functionality that allows other software modules to perform tasks in an easier fashion than by interfacing directly with the underlying operating system 1114 functionality (e.g., kernel 1128, services 1130, and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be used by the applications 1120 and/or other software components/modules. For example, the frameworks 1118 may provide various graphical user interface (GUI) functions, high-level resource management, high-level location services, and so forth. The frameworks 1118 may provide a broad spectrum of other APIs that may be used by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. The third-party applications 1142 may include any of the built-in applications 1140 as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1142 may invoke the API calls 1124 provided by the mobile operating system such as the operating system 1114 to facilitate functionality described herein.

The applications 1120 may use built-in operating system functions (e.g., kernel 1128, services 1130, and/or drivers 1132), libraries (e.g., system libraries 1134, API libraries 1136, and other libraries 1138), or frameworks/middleware 1118 to create user interfaces to interact with users of the system. Alternatively, or additionally, in some systems, interactions with a user may occur through a presentation layer, such as the presentation layer 1144. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 11, this is illustrated by a virtual machine 1148. A virtual machine creates a software environment where applications/modules can execute as if they were executing on a hardware computing device. The virtual machine 1148 is hosted by a host operating system (e.g., the operating system 1114) and typically, although not always, has a virtual machine monitor 1146, which manages the operation of the virtual machine 1148 as well as the interface with the host operating system (e.g., the operating system 1114). A software architecture executes within the virtual machine 1148, such as an operating system 1150, libraries 1152, frameworks/middleware 1154, applications 1156, and/or a presentation layer 1158. These layers of software architecture executing within the virtual machine 1148 can be the same as corresponding layers previously described or may be different.

FIG. 12 is a block diagram illustrating a computing device hardware architecture 1200, within which a set or sequence of instructions can be executed to cause a machine to perform examples of any one of the methodologies discussed herein. The architecture 1200 may describe a computing device for executing the vehicle autonomy system, center-of mass system, etc., described herein.

The architecture 1200 may operate as a standalone device or may be connected (e.g., networked) to other machines. In a networked deployment, the architecture 1200 may operate in the capacity of either a server or a client machine in server-client network environments, or it may act as a peer machine in peer-to-peer (or distributed) network environments. The architecture 1200 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1200 includes a processor unit 1202 comprising at least one processor (e.g., a central processing unit (CPU), a graphics processing unit (GPU), or both, processor cores, compute nodes, etc.). The architecture 1200 may further comprise a main memory 1204 and a static memory 1206, which communicate with each other via a link 1208 (e.g., bus). The architecture 1200 can further include a video display unit 1210, an input device 1212 (e.g., a keyboard), and a UI navigation device 1214 (e.g., a mouse). In some examples, the video display unit 1210, input device 1212, and UI navigation device 1214 are incorporated into a touchscreen display. The architecture 1200 may additionally include a storage device 1216 (e.g., a drive unit), a signal generation device 1218 (e.g., a speaker), a network interface device 1220, and one or more sensors (not shown), such as a Global Positioning System (GPS) sensor, compass, accelerometer, or other sensor.

In some examples, the processor unit 1202 or another suitable hardware component may support a hardware interrupt. In response to a hardware interrupt, the processor unit 1202 may pause its processing and execute an ISR, for example, as described herein.

The storage device 1216 includes a machine-readable medium 1222 on which is stored one or more sets of data structures and instructions 1224 (e.g., software) embodying or used by any one or more of the methodologies or functions described herein. The instructions 1224 can also reside, completely or at least partially, within the main memory 1204, within the static memory 1206, and/or within the processor unit 1202 during execution thereof by the architecture 1200, with the main memory 1204, the static memory 1206, and the processor unit 1202 also constituting machine-readable media.

Executable Instructions and Machine-Storage Medium

The various memories (i.e., 1204, 1206, and/or memory of the processor unit(s) 1202) and/or storage device 1216 may store one or more sets of instructions and data structures (e.g., instructions) 1224 embodying or used by any one or more of the methodologies or functions described herein. These instructions, when executed by processor unit(s) 1202 cause various operations to implement the disclosed examples.

As used herein, the terms “machine-storage medium,” “device-storage medium,” “computer-storage medium” (referred to collectively as “machine-storage medium 1222”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 1222 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 1222 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 1224 can further be transmitted or received over a communications network 1226 using a transmission medium via the network interface device 1220 using any one of a number of well-known transfer protocols (e.g., HTTP). Examples of communication networks include a LAN, a WAN, the Internet, mobile telephone networks, plain old telephone service (POTS) networks, and wireless data networks (e.g., Wi-Fi, 3G, 4G LTE/LTE-A, 5G or WiMAX networks). The term “transmission medium” shall be taken to include any intangible medium that is capable of storing, encoding, or carrying instructions for execution by the machine, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

1. A system to monitor a vehicle, comprising:
at least one processor unit programmed to perform operations comprising:
accessing first slope data indicative of a first slope referenced to a cab of the vehicle;
accessing second slope data indicative of a second slope independent of the cab of the vehicle; and
generating cab tilt data indicative of a cab tilt of the cab using the first slope data and the second slope data.

2. The system of claim 1, further comprising a first remote-detection sensor, wherein the at least one processor unit is further programmed to perform operations comprising:
determining, using the cab tilt data, that a road surface is in a field-of-view of the first remote-detection sensor;
correcting remote sensor data received from the first remote-detection sensor to generate corrected remote sensor data; and
determining a vehicle pose for the vehicle using the corrected remote sensor data.

3. The system of claim 1, wherein the at least one processor unit is further programmed to perform operations comprising receiving a slope sensor signal, wherein the first slope data is based at least in part on the slope sensor signal.

4. The system of claim 1, further comprising a first remote-detection sensor, wherein the at least one processor unit is further programmed to perform operations comprising:
receiving remote sensor data from the first remote-detection sensor;
determining a vehicle position using the remote sensor data;
determining a vehicle direction; and
accessing map data describing a gradient at the vehicle position, wherein the second slope data is generated using the vehicle direction and the gradient.

5. The system of claim 1, further comprising a first remote-detection sensor, wherein the at least one processor unit is further programmed to perform operations comprising:
receiving remote sensor data from the first remote-detection sensor;
determining a vehicle position using the remote sensor data, wherein the vehicle position corresponds to a roadway;
determining a direction of travel of the vehicle on the roadway; and
determining a grade of the roadway in the direction of travel at the vehicle position, wherein the second slope is generated using the grade of the roadway and the direction of travel.

6. The system of claim 1, further comprising a first remote-detection sensor, further comprising a slope sensor, wherein the at least one processor unit is further programmed to perform operations comprising:
receiving remote sensor data from the first remote-detection sensor;
determining a vehicle pose using the remote sensor data and map data, wherein the vehicle pose comprises a pose slope referenced to a pose reference frame;
receiving a slope sensor signal from the slope sensor;
determining a gravity vector direction using the slope sensor signal; and
generating an adjusted slope referenced to a measured reference frame using a direction of the gravity vector and the pose slope, wherein the first slope is generated using the adjusted slope.

7. The system of claim 6, wherein the at least one processor unit is further programmed to perform operations comprising:
determining a gravitational force on the vehicle based at least in part on the second slope;
determining a throttle command using the gravitational force, a target acceleration, and a target speed; and
throttling an engine of the vehicle using the throttle command.

8. The system of claim 1, wherein the at least one processor unit is further programmed to perform operations comprising:
receiving slope sensor data;
receiving a vehicle pose; and
executing a Kalman filter based on the slope sensor data and the vehicle pose to determine the second slope.

9. A method of monitoring a vehicle, comprising:
accessing, by at least one processor unit, first slope data indicative of a first slope referenced to a cab of the vehicle;
accessing, by the at least one processor unit, second slope data indicative of a second slope independent of the cab of the vehicle; and
generating, by the at least one processor unit, cab tilt data indicative of a cab tilt of the cab using the first slope data and the second slope data.

10. The method of claim 9, further comprising:
determining, by the at least one processor unit and using the cab tilt data, that a road surface is in a field-of-view of a first remote-detection sensor;
correcting, by the at least one processor unit, remote sensor data received from the first remote-detection sensor to generate corrected remote sensor data; and
determining, by the at least one processor unit, a vehicle pose for the vehicle using the corrected remote sensor data.

11. The method of claim 9, further comprising receiving, by the at least one processor unit, a slope sensor signal, wherein the first slope data is based at least in part on the slope sensor signal.

12. The method of claim 9, further comprising:
receiving, by the at least one processor unit, remote sensor data from a first remote-detection sensor;
determining, by the at least one processor unit, a vehicle position using the remote sensor data;
determining, by the at least one processor unit, a vehicle direction; and
accessing, by the at least one processor unit, map data describing a gradient at the vehicle position, wherein the second slope data is generated using the vehicle direction and the gradient.

13. The method of claim 9, further comprising:
receiving remote sensor data from a first remote-detection sensor;
determining, by the at least one processor unit, a vehicle position using the remote sensor data, wherein the vehicle position corresponds to a roadway;
determining, by the at least one processor unit, a direction of travel of the vehicle on the roadway; and
determining, by the at least one processor unit, a grade of the roadway in the direction of travel at the vehicle position, wherein the second slope is generated using the grade of the roadway and the direction of travel.

14. The method of claim 9, further comprising:
receiving, by the at least one processor unit, remote sensor data from a first remote-detection sensor;
determining, by the at least one processor unit, a vehicle pose using the remote sensor data and map data, wherein the vehicle pose comprises a pose slope referenced to a pose reference frame;
receiving, by the at least one processor unit, a slope sensor signal from a slope sensor;
determining, by the at least one processor unit, a gravity vector direction using the slope sensor signal; and
generating an adjusted slope referenced to a measured reference frame using a direction of the gravity vector and the pose slope, wherein the first slope is generated using the adjusted slope.

15. The method of claim 9, further comprising:
determining, by the at least one processor unit, a gravitational force on the vehicle based at least in part on the second slope;
determining, by the at least one processor unit, a throttle command using the gravitational force, a target acceleration, and a target speed; and
throttling, by the at least one processor unit, an engine of the vehicle using the throttle command.

16. The method of claim 9, further comprising:
receiving, by the at least one processor unit, slope sensor data;
receiving, by the at least one processor unit, a vehicle pose; and
executing, by the at least one processor unit, a Kalman filter based on the slope sensor data and the vehicle pose to determine the second slope.

17. A machine-readable medium comprising instructions thereon that, when executed by at least one processor unit, cause the at least one processor unit to perform operations comprising:
accessing first slope data indicative of a first slope referenced to a cab of a vehicle;
accessing second slope data indicative of a second slope independent of the cab of the vehicle; and
generating cab tilt data indicative of a cab tilt of the cab using the first slope data and the second slope data.

18. The machine-readable medium of claim 17, further comprising thereon instructions that, when executed by the at least one processor unit, cause the at least one processor unit to perform operations comprising:
determining, using the cab tilt data, that a road surface is in a field-of-view of a first remote-detection sensor;
correcting remote sensor data received from the first remote-detection sensor to generate corrected remote sensor data; and
determining a vehicle pose for the vehicle using the corrected remote sensor data.

19. The machine-readable medium of claim 17, further comprising thereon instructions that, when executed by the at least one processor unit, cause the at least one processor unit to perform operations comprising receiving, by the at least one processor unit, a slope sensor signal, wherein the first slope data is based at least in part on the slope sensor signal.

20. The machine-readable medium of claim 17, further comprising thereon instructions that, when executed by the at least one processor unit, cause the at least one processor unit to perform operations comprising:
receiving remote sensor data from a first remote-detection sensor;
determining a vehicle position using the remote sensor data;
determining a vehicle direction; and
accessing map data describing a gradient at the vehicle position, wherein the second slope data is generated using the vehicle direction and the gradient.
